(19) United States
(12) Patent Application Publication
(10) Pub. No.: US 2009/0145870 A1
(43) Pub. Date: Jun. 11, 2009

(54) COLLAPSIBLE SUPPORT APPARATUS AND METHODS

(75) Inventors: Randall E. Tagawa, Broomfield, CO (US); Richard D. Henwood, Arroyo Grande, CA (US)

Correspondence Address: SANTANGELO LAW OFFICES, P.C., 125 SOUTH HOWES, THIRD FLOOR, FORT COLLINS, CO, 80521, US

(73) Assignee: Tagawa Greenhouse Enterprises, LLC, Brighton, CO (US)

(21) Appl. No.: 12/315,878

(22) Filed: Dec. 5, 2008

Related U.S. Application Data
(60) Provisional application No. 60/992,617, filed on Dec. 5, 2007.

(51) Int. Cl. A47B 47/00; A47B 43/00

(52) U.S. Cl. 211/190; 211/195; 47/44

(57) ABSTRACT

Methods and apparatus may permit the propagation and distribution of plants, or merely storage and/or shipment of items, in a space efficient manner. Individual apparatus may be stacked in a rack system. Space between individual stacked apparatus may be varied to accommodate plants of various sizes and permit varying degrees of air flow. Individual apparatus may be collapsed into smaller units without removable hardware and with all components remaining connected at all times. Apparatus may be delivered in a fully assembled stated and returned in a state of reduced size, minimizing transportation costs and efficiently utilizing transportation resources.

This US non-provisional patent application claims priority to U.S. Provisional Patent Application 60/992,617, filed Dec. 5, 2007, said provisional application hereby incorporated herein by reference.

### BACKGROUND OF THE INVENTION

Generally, the inventive technology may involve a support apparatus (e.g., a type of rack) for storing and/or shipping plants or other goods; the apparatus may be reduced in size upon collapsing from a support configuration to a collapsed configuration, thereby occupying less space, so that shipping or storing the apparatus is economical. The apparatus may be particularly suited for use with punched plant growing techniques, as exemplified perhaps by PUNCHABLES® brand systems and products, or perhaps as described in or related to any of U.S. Pat. No. 6,184,449, issued Feb. 6, 2001, U.S. Pat. No. 6,723,839, issued Apr. 20, 2004, U.S. Pat. No. 6,779,300, issued Aug. 24, 2004, U.S. Pat. No. 6,915,607, issued Jul. 12, 2005, U.S. Pat. No. 7,069,693, issued Jul. 4, 2006, U.S. patent application Ser. No. 10/590,919, filed Aug. 25, 2006, and U.S. patent application Ser. No. 10/599,107, filed Sep. 19, 2006, each hereby incorporated herein by reference.

The distribution of punched plant products or other goods may require protection for the plants or products to prevent crushing or other damage. Plants may also require prevention of disease or etiolation perhaps due to shipping in a confined space such as a box. Typical shipping methods may involve containers such as cardboard boxes of varying strengths, plastic boxes, or other materials perhaps designed to be stacked on top of each other. Some shipping methods may involve shipping the plants or goods on a rack designed to hold multiple layers.

If a shipping container is used, the plant or product may need to be packed and unpacked, perhaps requiring the shipping container to be disposed of in an appropriate manner. This may cause problems perhaps of both inefficient use of time while packing and unpacking the product and disposing the shipping container, which may create excessive garbage or waste. Garbage disposal may increase costs and risks to the environment. Moreover, shipping plants in a box may dramatically increase the risk of disease or etiolation, perhaps due to the confined nature of the box, which may prevent air flow.

If the shipping containers are reusable by the manufacturer, typically they may need to be returned to the manufacturer. Some shipping containers may not be able to be collapsed or broken down into smaller units, perhaps causing problems such as storing the shipping container until it can be returned or resulting in unnecessarily high transportation costs when the shipping container is returned because such conventional support apparatus are often not reducible in size, or are only reducible in size upon labor intensive dismantling or destruction.

Although some shipping containers (a type of support apparatus) may be able to be collapsed or broken down into smaller units, the process often may be time consuming, inefficient, and possibly expensive, for example perhaps because of the labor involved to take the container apart and keep track of all the pieces. This may cause a problem of a lack of incentive for the buyer to return the shipping container and may result in increased costs.

If the plants or goods are shipped on a conventional support apparatus, the plants or goods may be easily packed and unpacked, but conventional support apparatus typically may be large and heavy, and perhaps may need to be returned to the manufacturer or disposed of in an appropriate manner. Moreover, for plants it may be critical to control the use of space between the support apparatus, for example perhaps to provide optimum air flow between the layers to mitigate disease and etiolation. Etiolation may be due to excessive buildup of ethylene, a naturally occurring gas typically given off by plants, which may cause elongation of stems and petioles, general yellowing, and eventual death.

If the conventional rack can be reused by the manufacturer, the racks typically may need to be returned to the manufacturer. Generally, conventional rack systems may not be able to be collapsed or broken down into smaller units. This perhaps may increase transportation costs and inefficiencies, in as much as an empty returned rack may take up as much transportation space as a delivered full rack (e.g., a 1:1 ratio of trucking space). This may result in increased return shipping costs, which typically may be passed to the buyer of the product.

If a conventional rack system is able to be collapsed or broken down into smaller units, that process often may be difficult and time consuming due to perhaps the prevailing constructions of conventional racks. For example, parts perhaps may be heavy, easily misplaced, and often may need to be associated with the particular rack that is being collapsed. This may cause problems of adding cost to the rack system return process, for example due to the weight of the rack materials, perhaps resulting in a low ratio of return space to shipping space (e.g., often less than 3:1), and possibly the loss of parts, resulting in returned racks that may not be able to be reassembled or incurring additional costs for replacing lost parts.

Some racks may be disposable, but because these systems often may have many parts to create multiple layers necessary for efficient shipping, they may have environmentally unfriendly effects.

Before shipping and/or after receiving, the plants or goods may need to be displayed or arranged for assembly, production, inspection, or other tasks. After this process, the plants or goods may need to be handled again, for example perhaps to be packed in shipping containers or racks or to be displayed. This additional handling—a feature inherent in methods using conventional support racks—may cause problems of additional labor costs and increased potential for damage, contamination, or waste. Use of a support rack according to particular embodiments of the inventive technology, where such rack may be established on a table (or indeed, the floor) and then immediately placed on, e.g., a truck for shipment, may render such additional handling step unnecessary. Having the correct height of a support rack, for example to coordinate with growing plants or to reduce strain on a worker's back by bending over—whether such rack is stacked atop another or supported on a table or floor—also may be critical to reducing costs.

The foregoing problems regarding the distribution of plants or other products may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

### SUMMARY OF THE INVENTION

In various embodiments, a support apparatus (an apparatus such as a rack that may be used to support one or more items) may allow users to quickly and easily reduce the size of the racks, such as by collapsing the racks, for reduced transportation and storage costs.

In a multiple layer rack system (where apparatus are stacked upon one another), each layer may be able to be set out individually (whether established on a conventional support (e.g., a table) or not), perhaps allowing a punched plant producer to grow plants and a manufacturer to assemble, produce, or inspect the goods easily prior to or after shipping. Each layer may have feet which may be variable in height, perhaps allowing for the correct air flow beneath the layer to encourage optimum root growth on a plant growing on the layer (whether before or during shipment), or perhaps even to provide the correct height for a manufacturer assembling, inspecting, or displaying goods. The height of the layer may also be varied to an optimum height, for example to prevent back strain on workers handling products on the bench, or, during shipment, to allow for an optimum airflow beneath the support rack and the items supported thereby. The entire layer perhaps may be picked up, such as perhaps to reduce handling labor or possibly even potential damage to plants or goods. Layers then may be readily stacked, perhaps creating a distribution system that may allow for efficient and possibly less expensive transportation. The distance between each layer may also be varied, perhaps to maximize the efficiency of the distribution system while protecting the product, and optimize airflow. This may also allow for quick and easy packing and unpacking of the plants or goods. When utilizing the rack, many plants or goods might not require any other packing materials, and perhaps could be shipped “loose” on the rack system, thereby perhaps further reducing disposal costs and increasing efficiencies.

Growing punched plants, such as PUNCHABLES® brand plants, may require a correct ratio of root to shoot (perhaps as noted in U.S. Pat. No. 6,779,300, issued Aug. 24, 2004, and U.S. Pat. No. 7,069,693, issued Jul. 4, 2006, each hereby incorporated herein by reference). The rack system may provide the correct air flow beneath a punched plant tray, such as a PUNCHABLES® brand tray, to cause air root pruning. Air root pruning may occur when roots come into contact with sufficient air and air movement perhaps to cause them to dry up and die off. Air root pruning may be critical to cause punched plant plugs, such as PUNCHABLES® brand plugs, to form a desired heavy root system due to the naturally occurring branching that may take place with roots when roots dry and die off. The space between the layers of the rack system, whether on the floor and being used as a bench or stacked together to form a multiple layer rack system, may be determined by the length of the feet of a particular layer. In some embodiments, to most effectively maximize space utilization between layers and most effectively utilize the air flow beneath a punched plant tray, such as a PUNCHABLES® brand tray, the length of the feet may range from between 3 inches for very small plants and as much as 24 inches for larger plants.

The support apparatus perhaps may be capable of quick and easy assembly. The components may be connected so everything needed to assemble an individual layer may be available, perhaps without looking for specialized parts or requiring tools.

When not in use, the rack system may be perhaps easily collapsed. For example, in some embodiments simply folding components of the apparatus together may effect reconfiguration of the apparatus from support configuration to collapsed configuration. The components of the rack system may be all connected (directly and indirectly) in various embodiments, perhaps preventing them from becoming lost, and avoiding the need for any disassembly during reconfiguration of the apparatus. Each layer of the apparatus, when layered, may be light and may be susceptible to easy handling by perhaps even a single person. Any individual layer in a multiple layer rack system may be completely compatible with all other layers in the system, such that one can be easily stacked upon the other, perhaps preventing the need for unique parts required to build a rack.

The individual support apparatus may be reduced in size, such as perhaps by collapsing, at any of various ratios consistent with the principles discussed herein. For example, embodiments may involve reducing the size of the system from ratios of between 5:1 and 30:1, such as 10:1, 15:1, 20:1, or 25:1 (or within any ranges defined thereby) meaning that, for example, 30 collapsed racks may take the space of a single assembled rack. This may result in reduced storage space requirements and reduced transportation costs to return the rack system.

The rack system in various embodiments also may be environmentally sound. Because it may be returned at reduced transportation costs, the system may save fuel costs and reduce dependency on oil. Reusability also may eliminate waste from shipping and reduce garbage going into landfills. The apparatus may provide a sustainable solution for the problem of shipping products that require a shipping container or rack.

### BRIEF DESCRIPTION OF THE DRAWINGS

FIG. 1A shows a plan view of an embodiment of the support apparatus in support configuration.

FIG. 1B shows a plan view of embodiment of the support apparatus in collapsed configuration.

FIG. 2A shows a plan view of an embodiment of the support apparatus in support configuration.

FIG. 2B shows a plan view of embodiment of the support apparatus in collapsed configuration.

FIG. 3A shows a plan view of an embodiment of the support apparatus in support configuration.

FIG. 3B shows a plan view of embodiment of the support apparatus in collapsed configuration.

FIG. 4A shows a plan view of an embodiment of the support apparatus in support configuration.

FIG. 4B shows a plan view of embodiment of the support apparatus in collapsed configuration.

FIG. 5A shows a plan view of an embodiment of the support apparatus in support configuration.

FIG. 5B shows a plan view of embodiment of the support apparatus in collapsed configuration.

FIG. 6A shows a plan view of an embodiment of the support apparatus in support configuration.

FIG. 6B shows a plan view of embodiment of the support apparatus in collapsed configuration.

FIG. 7A shows a plan view of an embodiment of the support apparatus in support configuration.

FIG. 7B shows a plan view of embodiment of the support apparatus in collapsed configuration.

FIG. 8A shows a side view of an embodiment of the support apparatus in support configuration.

FIG. 8B shows a side view of an embodiment of the support apparatus in collapsed configuration, with feet extended.

FIG. 8C shows a side view of an embodiment of the support apparatus in collapsed configuration, with feet retracted (for additional space savings).

FIG. 9 shows a side view of an embodiment of the support apparatus stacked atop one another, each in support configuration. Of course, when apparatus are stacked atop each other, each may be secured (at least against relative horizontal displacement) in fixed position relative to the apparatus directly below through the use of holes in each apparatus that are positioned and sized to receive a portion of a leg of the apparatus directly above.

FIGS. 10A, 10B and 10C show a plan view of an apparatus in support configuration, in a partial collapsed configuration, and in collapsed configuration, respectively. The figures show pure revolutionary motion of the two rigid, horizontal outer supports during the reconfiguration process.

FIG. 11A shows a side view of an embodiment of the support apparatus in support configuration, with trays of punched plants on it.

FIG. 11B shows an individual tray of punched plants.

FIG. 11C shows the tray of punched plants turned upside down to show drainage slits at the bottom of each individual cell where roots may grow out.

FIG. 11D shows a close-up of the bottom of an individual cell with the drainage slits and roots growing out.

FIG. 11E shows a cross section of an individual punched plant cell with a plant well rooted, roots that have dried and died off, and the plant being pushed through the bottom of the cell by a punch pin. This may illustrate the concept of having a well rooted punched plant to allow the plant to be “punched” through the bottom of the cell.

FIG. 12 shows a side view of stacked apparatus, in an embodiment, with varied foot lengths creating a stacked rack to perhaps accommodate a wide variety of different sized plants. The varied foot lengths also may improve air flow, perhaps causing improved air root pruning. The varied foot length also may accommodate products other than plants of different heights. FIG. 2 shows plants as an example of the differing height potential of each stacked apparatus.

FIG. 13 shows the apparatus from the top down in an embodiment. This view shows the system in support configuration.

FIG. 14 is a side view showing individual apparatus stacked on each other to form a multiple layer rack system in an embodiment.

FIG. 15 is a partial three dimensional view of stacked apparatus in partial exploded view, in an embodiment. This may illustrate the concept of stacking apparatus of a multiple support apparatus system and how the layers may be held together with pegs.

FIG. 16 shows an embodiment of the inventive technology in collapsed configuration. A cross bar has been swiveled and spreader bars have been removed, allowing elastic straps to pull the entire apparatus together into a compact unit.

FIG. 17 shows four individual apparatus in an embodiment, laid out in a pattern example of 2×2 to form a bench or table area.

FIG. 18 shows apparatus placed on a shipping pallet for movement in partial exploded view, in an embodiment.

FIG. 19 shows apparatus placed on a wheeled cart for movement, in an embodiment.

FIG. 20 shows an example of Possion's Ratio for an elastic strap in one embodiment relating the strap's elasticity to its diameter.

### DETAILED DESCRIPTION OF THE PREFERRED EMBODIMENTS

As mentioned earlier, the present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

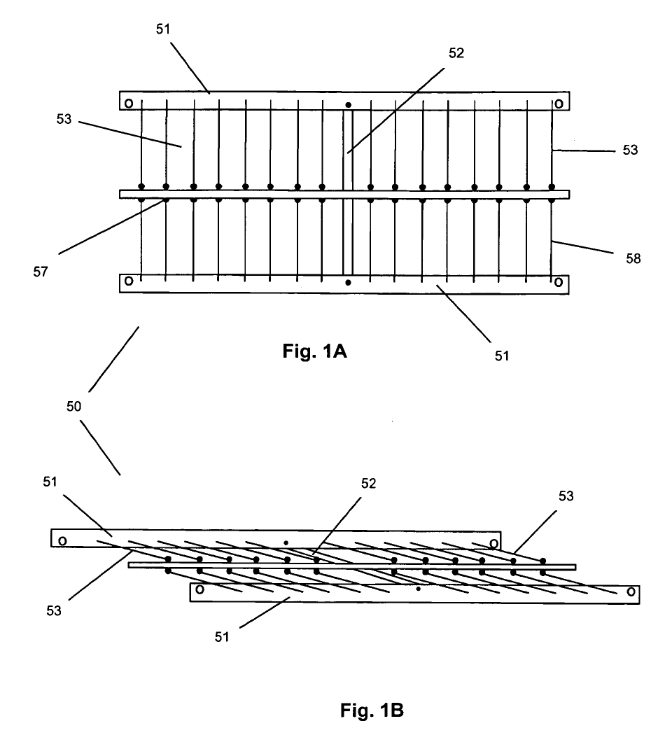

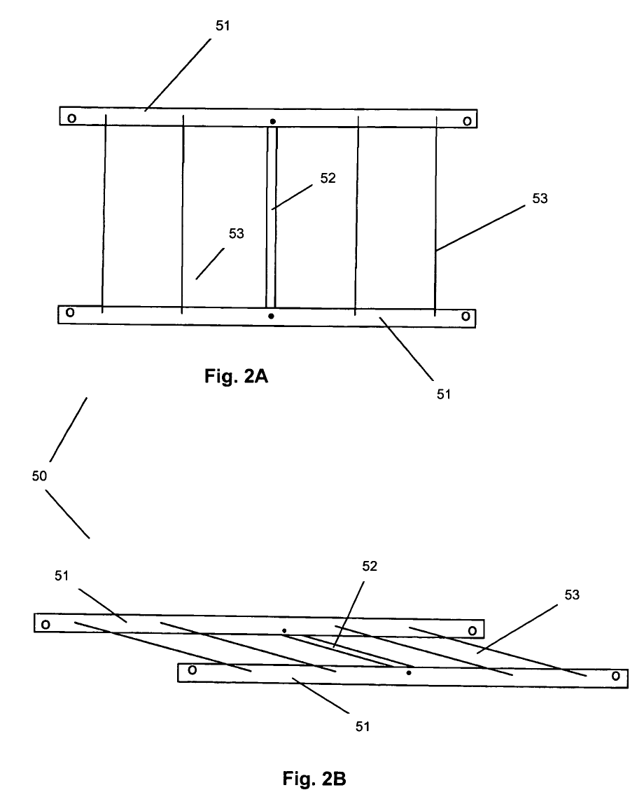

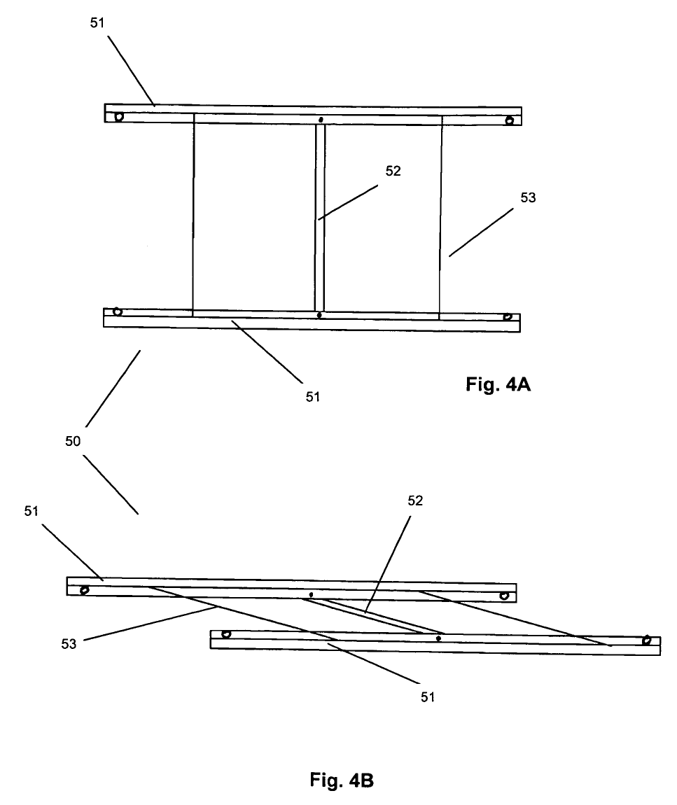

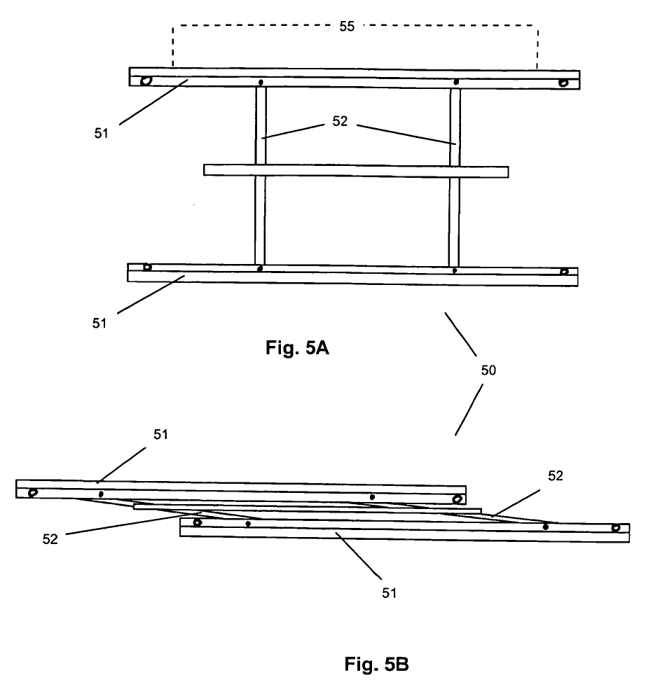

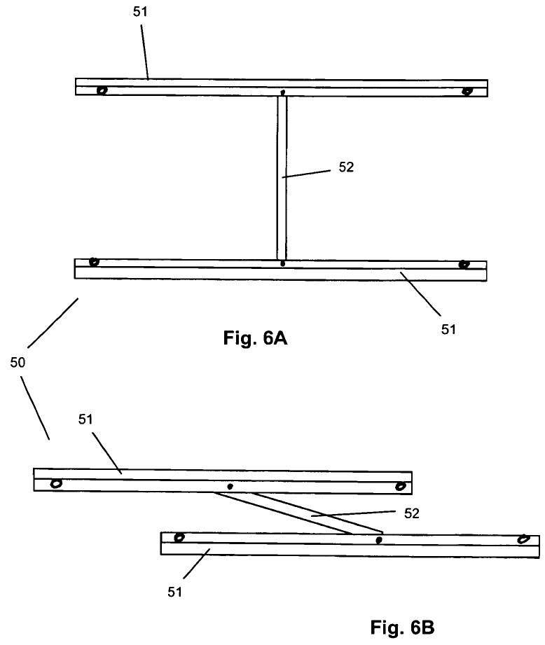

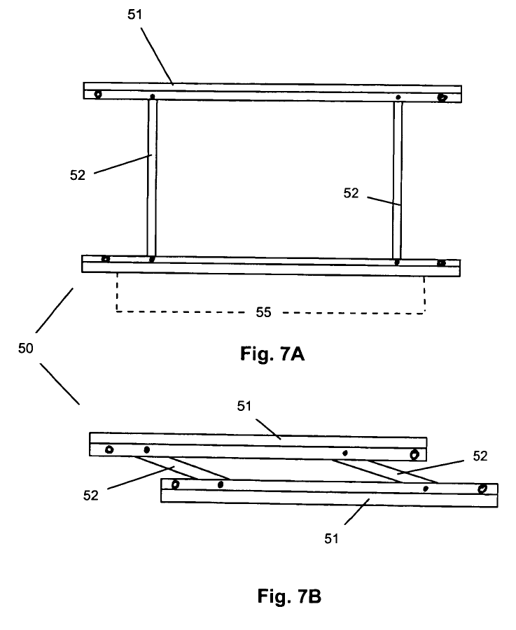

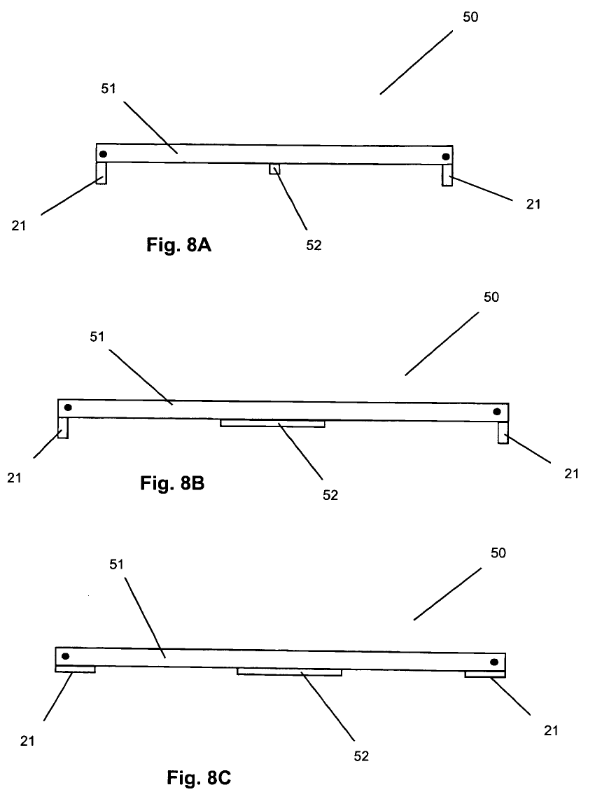

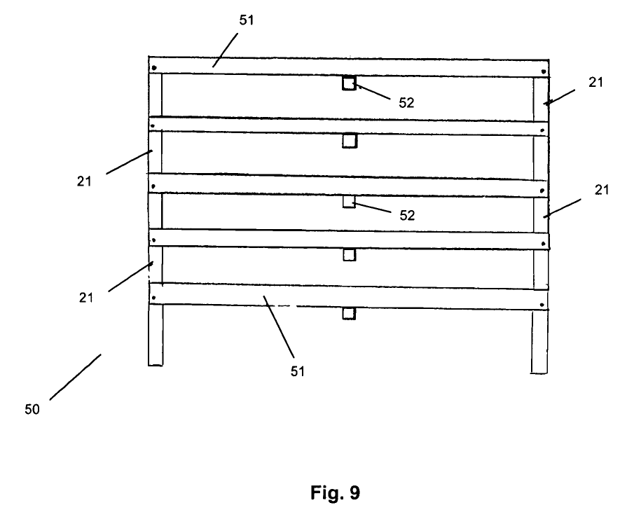

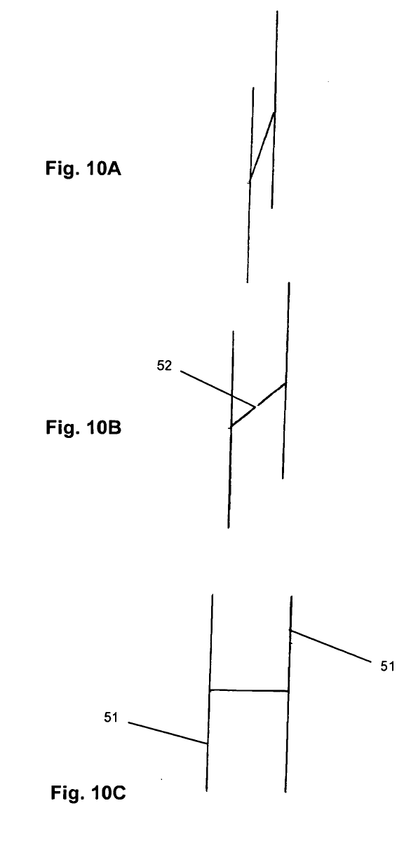

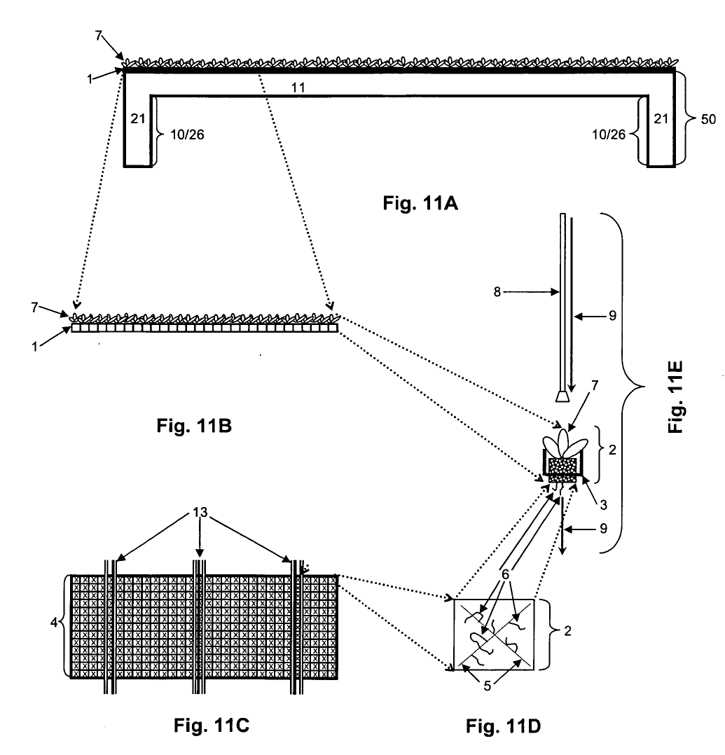

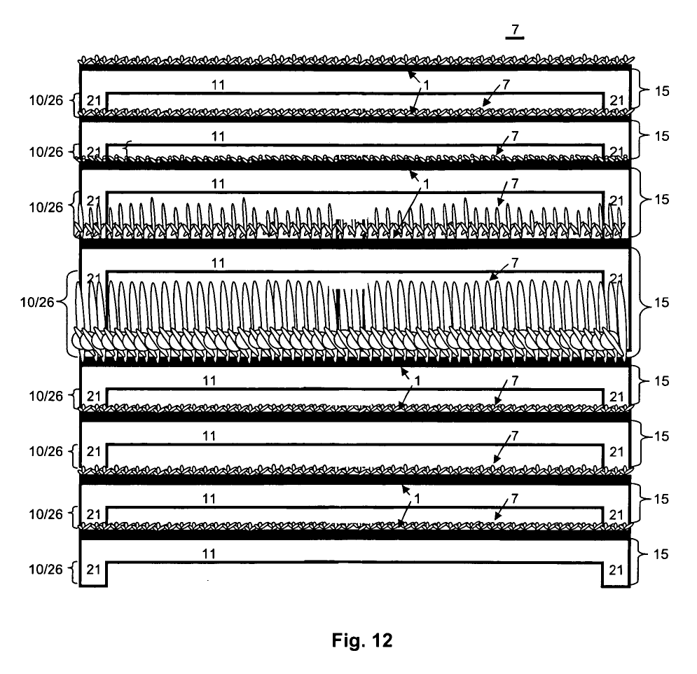

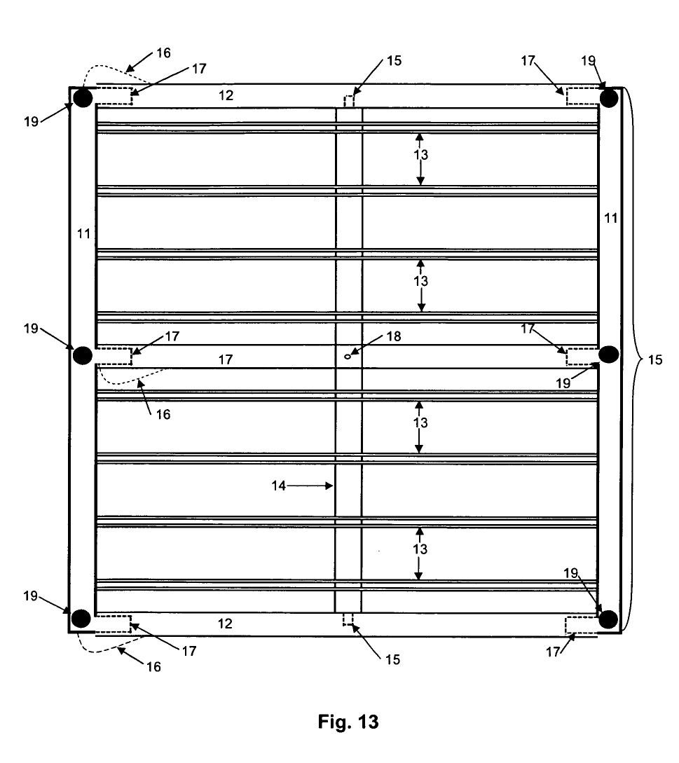

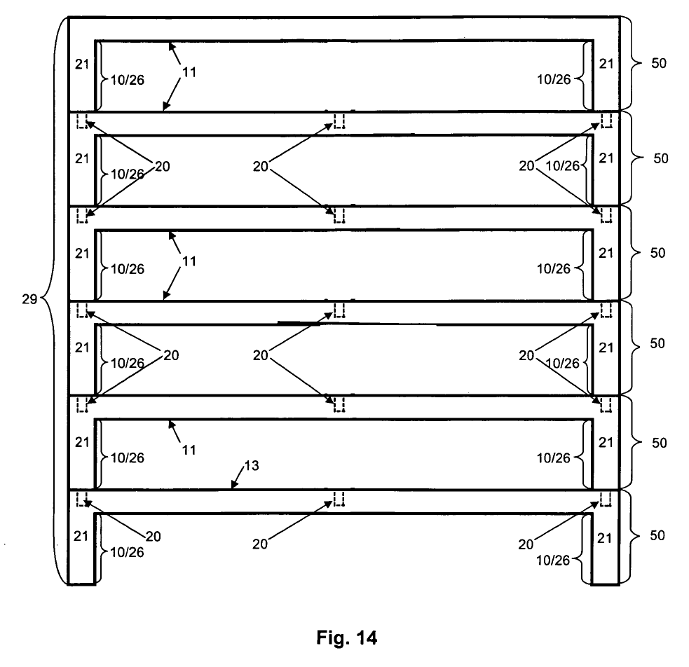

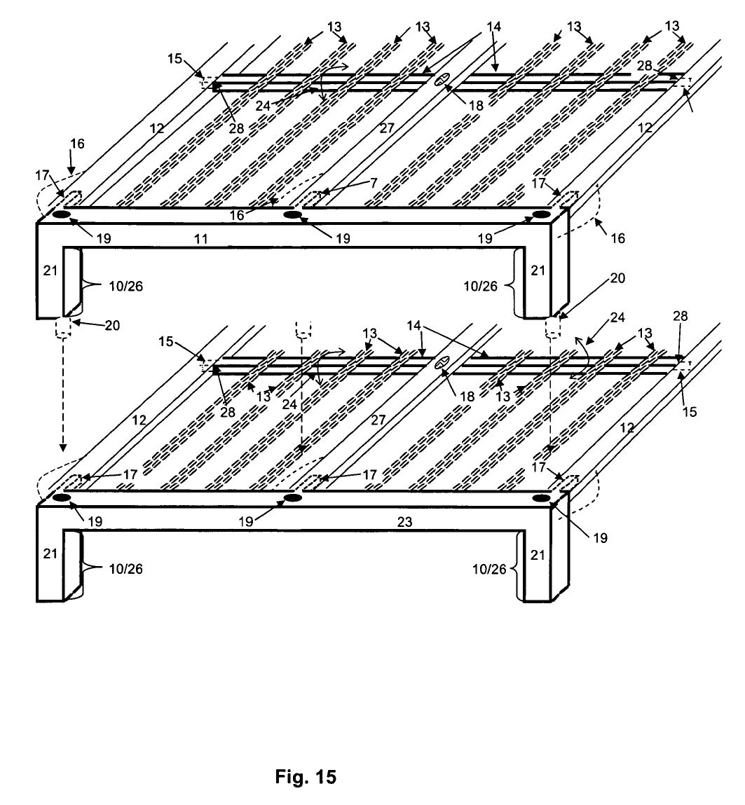

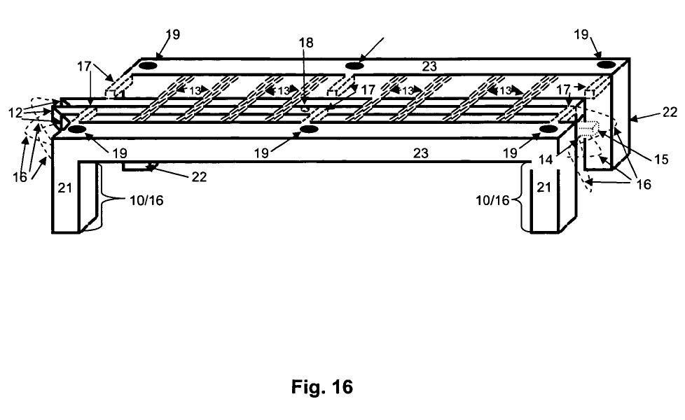

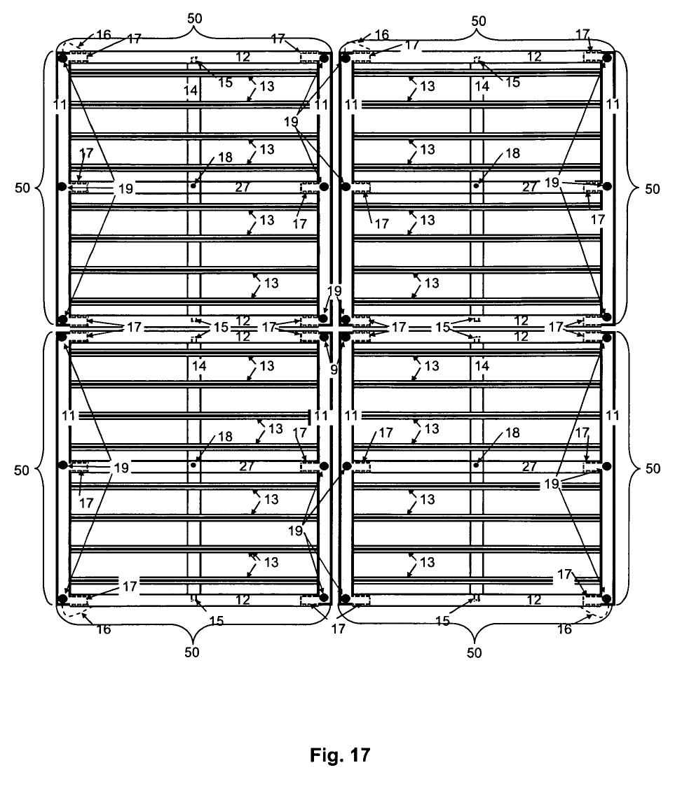

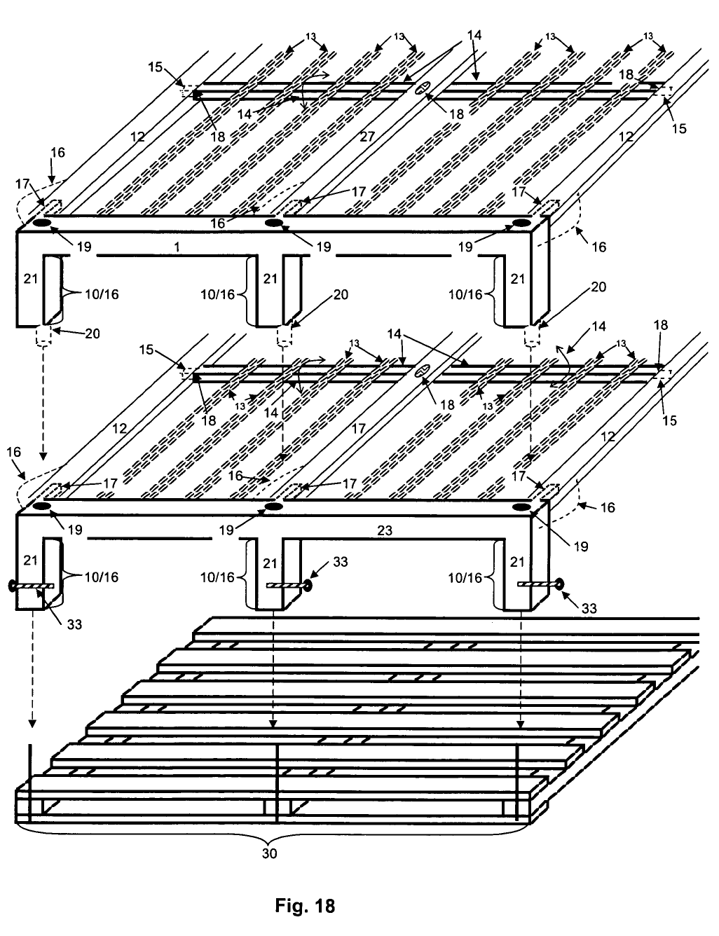

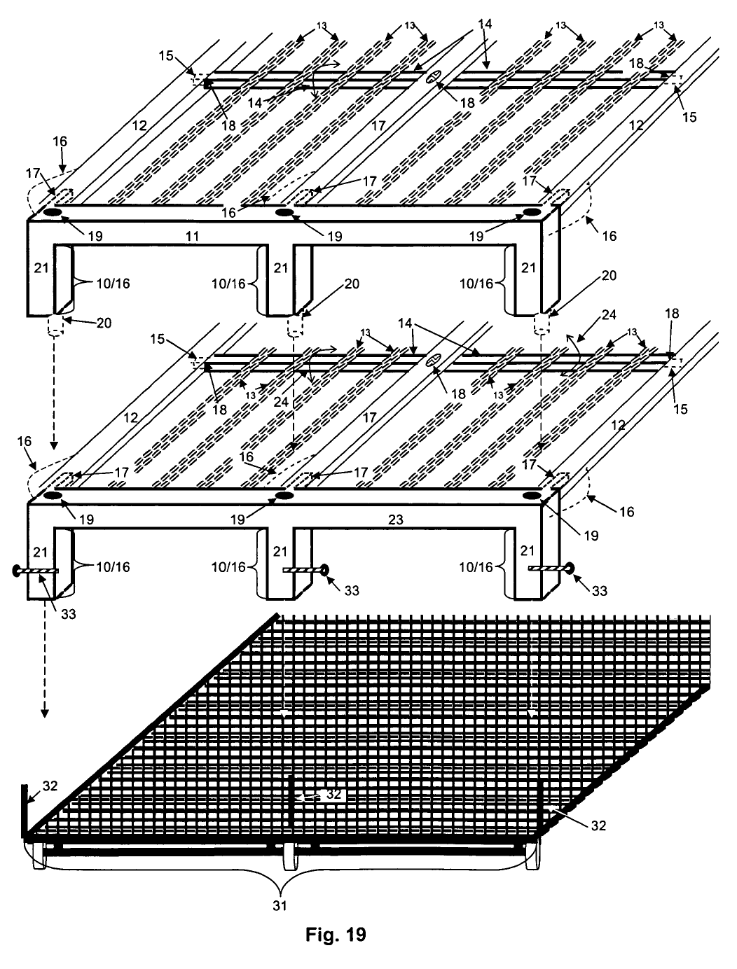

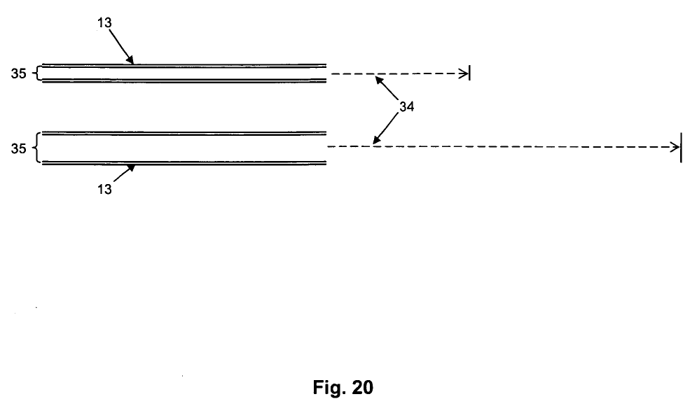

At least one embodiment of the inventive technology, particularly limited to include a first aspect of the inventive technology, may be described as a support apparatus 50 that is reconfigurable between support (see, e.g., FIGS. 1A-8A) and collapsed configurations (see, e.g., FIGS. 1B-8B) and that comprises only two (no more, no fewer) rigid, horizontal outer supports 51 that are parallel with each other when the apparatus is in the support configuration; a rigid horizontal support 52 pivotally connected with both the only two rigid, horizontal outer supports 51; and at least one additional horizontal support 53 pivotally connected with both the only two rigid, horizontal outer supports 51, where wherein the only two rigid, horizontal outer supports 51 are revolvable relative to each other.

At least one embodiment of the inventive technology, particularly limited to include a second aspect of the inventive technology, may be described as a support apparatus that is reconfigurable between support and collapsed configurations and that comprises two rigid, horizontal outer supports 51 that are parallel with each other when the apparatus is in the support configuration; a rigid horizontal support 52 pivotally connected with both the two rigid, horizontal outer supports 51; and at least two additional horizontal supports 53 pivotally connected with both the two rigid, horizontal outer supports 51, where wherein the two rigid, horizontal outer supports 51 are purely revolvable relative to each other.

At least one embodiment of the inventive technology, particularly limited to include a third aspect of the inventive technology, may be described as a support apparatus that is reconfigurable between support and collapsed configurations and that comprises two rigid, horizontal outer supports 51 that are parallel with each other when the apparatus is in the support configuration; a rigid horizontal support 52 pivotally connected with both the two rigid, horizontal outer supports 51; and at least two additional horizontal supports 53 pivotally connected with both the two rigid, horizontal outer supports 51, where the at least two additional horizontal supports 53 comprise at least two tensile displacement resisting supports 54, and where wherein the two rigid, horizontal outer supports 51 are revolvable relative to each other.

At least one embodiment of the inventive technology, particularly limited to include a fourth aspect of the inventive technology, may be described as a support apparatus that is reconfigurable between support and collapsed configurations and that comprises two rigid, horizontal outer supports 51 that are parallel with each other when the apparatus is in the support configuration; a rigid horizontal support 52 pivotally connected with both the two rigid, horizontal outer supports 51 at non-terminal portions 55 of the two rigid, horizontal outer supports 51, where at least two of the horizontal supports are pivotally connected with both of the two rigid, horizontal outer supports 51, and where wherein the two rigid, horizontal outer supports 51 are revolvable relative to each other. Advantages of connection at non-terminal ends include a reduction in the space occupied by the apparatus, particularly in collapsed configuration.

Of course, where the apparatus is said to comprise one, or two (or any other number) of referenced items, such describes apparatus that have the specified number of referenced items, and, indeed, because of the interpretation of the term “comprises”, even apparatus that have more than the specified number of items. Of course, where the term “consists of”, or “only” is used instead, such is not the case (i.e., a description limiting apparatus as having only two rigid, horizontal outer supports 51 does not cover apparatus having, e.g., only one, or three or more rigid, horizontal outer supports 51).

As mentioned, the term collapsed refers to the reduced space configuration to which the apparatus is reconfigured during storage and/or return shipment. The term merely implies that, upon reconfiguration into such collapsed configuration, the space occupied thereby is reduced, or smaller, as compared with that space occupied by the apparatus when it is in support configuration. Reconfiguration from support configuration to collapsed configuration may involve folding of the apparatus, whether after unlocking from support configuration or not; conversely, reconfiguration from collapsed configuration to support configuration may involve unfolding, a type of deployment. When the apparatus is in support configuration, it is deployed into that configuration that is particularly intended to support things such as, but not limited to one or more items such as trays of plants, or other items. Indeed, in at least one embodiment of the inventive apparatus, it may be characterized as a plant tray (or plant rack) support apparatus. However, the inventive technology is not limited to apparatus that merely support plant racks 1, as many other different items (e.g., racks or things) can be supported by the apparatus.

Outer supports 51 are those components of the apparatus that may lie along an edge of a shape (e.g., two opposing legs of a rectangle or square) defined by the apparatus. Rigid supports are not easily deformable when carrying a design load thereabove (i.e., any vertical deflection is not appreciable and perhaps not observable to the naked eye). They include but are not limited to bars, elongated members, bars that have an asymmetric cross-section (L-shaped, as but one example), and bars that have a symmetric cross-section.

Of course, as may be readily appreciated, motion of components relative to each other enables reconfiguration of the apparatus from a support configuration to a collapsed configuration, and from a collapsed configuration to a support configuration. Pivotal connections enable pivoting of connected components relative to each other; in preferred embodiments, a series of pivotal connections are established among various components of the apparatus, resulting in components which themselves are not directly connected with each other, that are revolvable with respect to each other. Of course, even where there is an additional type of motion superimposed on such revolutionary motion of such components, such revolutionary motion is said to exist. However, in certain preferred embodiments, such additional motion of components relative to each other does not exist, as the only observable motion is revolutionary (i.e., there is not possibility of rotation of one or more components about each of their axes); in such case the relative motion may be said to be pure revolution (or components are purely revolvable relative to each other). A relative rotation, when superimposed on revolutionary motion, would be akin to the rotation of the earth while it revolves around the sun, and would often result in oppositely established components that may be parallel in either support or collapsed configuration, but not parallel in the other such configuration. Indeed, pure relative revolution of oppositely established components (e.g., of rigid, horizontal outer supports 51), enables their parallel mutual establishment in both the support and the collapsed configurations. It is of note that relative translation is inherent in revolution, and such relative translational motion is not considered an additional type of motion.

Horizontal, when used in reference to any component (e.g., a support), merely indicates that the axis most characteristic of such component (e.g., the longitudinal axis in the case of a bar like support), is horizontal when the apparatus is in a support configuration. It says nothing about the positioning of such support when the apparatus is in collapsed configuration. Depending on how the apparatus, when in collapsed configuration, is stored or shipped (horizontally or vertically, as but two examples), the apparatus may or many not be horizontal when in collapsed configuration.

Any of the various embodiments described may further comprise at least four feet 21 that support the rigid, horizontal outer supports 51; in certain embodiments, such feet 21 may be height adjustable. Embodiments with at least one additional horizontal support 53 may comprise at least two additional horizontal supports 53. Each of the additional horizontal supports 53 (pivotally connected with the rigid, horizontal outer supports 51), in any of the embodiments described herein, may be tensile displacement resisting supports 54, which are simply supports that resist tensile displacement (e.g., cables, wires, or even elastic bands, rigid horizontal support 52, as but a few examples).

Pivotal connections may, in particular embodiments, be at respective non-terminal portions 55 of the rigid, horizontal outer supports 51. Such non-terminal portions 55 are portions of such supports that do not include the outer inch or so at the ends. It is of note that the term connection, as used in this description and in the claims, does not require that two parts connected thereto are entirely translationally immovable relative to each other. The term securely connected does however, imply such translational immovability.

Certain embodiments of the variously described aspects of the inventive technology may further comprise a rigid, horizontal inner support that is established in parallel relation with the rigid, horizontal outer supports 51; such rigid inner support may be supported by one or more of the one or more rigid horizontal supports 52 pivotally connected with the rigid, horizontal outer supports 51. Any additional horizontal supports 53 that exist may be supported by the rigid inner support, whether by a connection or simply by passing thereabove or therethrough (as but a few examples). In certain embodiments, the rigid inner support may additionally or instead be supported by additional horizontal supports 53.

It is of note that embodiments of the inventive technology that do not necessarily further comprise at least one additional horizontal support 53 pivotally connected with both the two rigid, horizontal outer supports 51, such may exist. In any embodiment at least two of the horizontal supports may be pivotally connected with both of the two rigid, horizontal outer supports 51 at non-terminal portions 55 of the two rigid, horizontal outer supports 51.

When the apparatus is in support configuration (i.e., when it is fully deployed to support, e.g., trays of items such as plant trays 1, and, e.g., when viewed from above, parts of define opposing sides of a square or rectangle), the rigid, horizontal outer supports 51 may be parallel with each other. Even where there are four such outer supports, this descriptive constraint may be said to be met where two outer supports are parallel each other and the remaining two outer supports (which may be orthogonal to the other outer supports) are parallel to each other. In collapsed configuration, the apparatus may occupy a space having the same height as does that space occupied by the apparatus when in support configuration. Further, even in collapsed configuration, the rigid, horizontal outer supports 51 may be parallel with each other. In either configuration, the apparatus may be stacked above other similarly configured apparatus (i.e., collapsed apparatus may be stacked above another collapsed apparatus while apparatus in support configuration may be stacked above another apparatus also in support configuration).

It is of note that in at least one embodiment, the apparatus, particularly where there are no lock mechanisms that lock the apparatus in support configuration, may be quickly collapsible. Quick collapsing with only one hand or one foot may be accomplished when the apparatus is not stacked upon another, upon moving with a hand or foot one of the outer supports towards the other, typically to effect a revolutionary motion of one outer support relative to the other. Such motion may be facilitated by tilting the entire apparatus to an off-horizontal position and/or placing one of the outer supports against a vertical obstruction such as a wall before moving one of the outer supports (e.g., the one that has been lifted off the ground, or the one that is not against the wall) towards the other. Of course, where apparatus are stacked atop one another and feet are engaged with a rack below, it will likely be necessary to lift the higher rack off the lower rack, thereby disengaging the feet from the rack below. A quick collapse in such situation could involve merely revolving the two outer supports relative to each other with a hand grasping each.

Of course, as mentioned, the support apparatus may be, and in a preferred embodiment is, reusable. The operational life of such reusable apparatus may be extended upon manufacturing the apparatus from a durable material such as metal, plastic or fiberglass (as but three of many examples), although certainly other, less durable materials, such as wood (as but one example) may be employed. The apparatus can be made using any well known manufacturing techniques (whether involving automated assembly or manual assembly); such would be obvious to one of ordinary skill in the art of support rack. The most complex aspect of a preferred embodiment of the apparatus may be pivotal connection(s), which can be easily established using, e.g., an appropriately tightened nut and bolt assembly, with perhaps two nuts in order to preclude loosening of the connection. Instead, particularly as regards any cables that serve as, e.g., additional horizontal supports 53, pivotal connections that they may form with the outer supports may be effected through a crimp 57 at the end of the cable, thereby preventing the removal of such cable from a hole in the outer support that it may pass through. In embodiments featuring a rigid inner support, where such support is, at least in part, itself supported by additional horizontal supports 53, such additional supports may simply pass over or through such inner support. In embodiments featuring a rigid inner support, where additional supports are cables 58 that pass through such inner support, crimps may be established on each of the cables immediately on either side of that part of the cable that passes through the inner support. In some of the other embodiments featuring a rigid inner support, any of the additional horizontal supports 53 may indeed by securely connected thereto.

At least one embodiment of the inventive technology may be described as a support apparatus 50 that is reconfigurable from a support configuration to a collapsed configuration and that comprises at least two spreader bars 12; two outer bars 11 engaged with the at least two spreader bars when the apparatus is in the support configuration; and a plurality of biasers 13 that bias the outer bars towards each other when the apparatus is in the support configuration, wherein the at least two spreader bars prevent the outer bars from moving towards each other when the apparatus is in support configuration. In preferred embodiments, the biasers are elastic straps 13. The apparatus may further comprise a cross bar 14 that is established parallel with and between the at least two outer bars 11 when the apparatus is in the support configuration. The cross bar 14 may be engaged with two of the at least two spreader bars 12 when the apparatus is in the support configuration. Further, the cross bar 14 may be removable from at least one (e.g., one or two) of the at least two spreader bars 12 (if indeed it is attached to them) when the apparatus is in the support configuration. In a preferred embodiment, at least one of the spreader bars 12 is pivotally connected with the cross bar 14, and the spreader bars 12 are removable from all but one of the outer bars 11. One or more of the pivotal connections, whether by nut and bolt or otherwise, may “lock” the apparatus in a support configuration. It is of note that certain terms used in the remainder of this application may indeed be types of components that may be referred to by the broader terms used in the preceding portion of the application. For example, the outer bar 11 may be a type of rigid outer support 51, and the biasers may be types of rigid horizontal supports 52. The following description describes a more narrow type of one of more of the previously described apparatus.

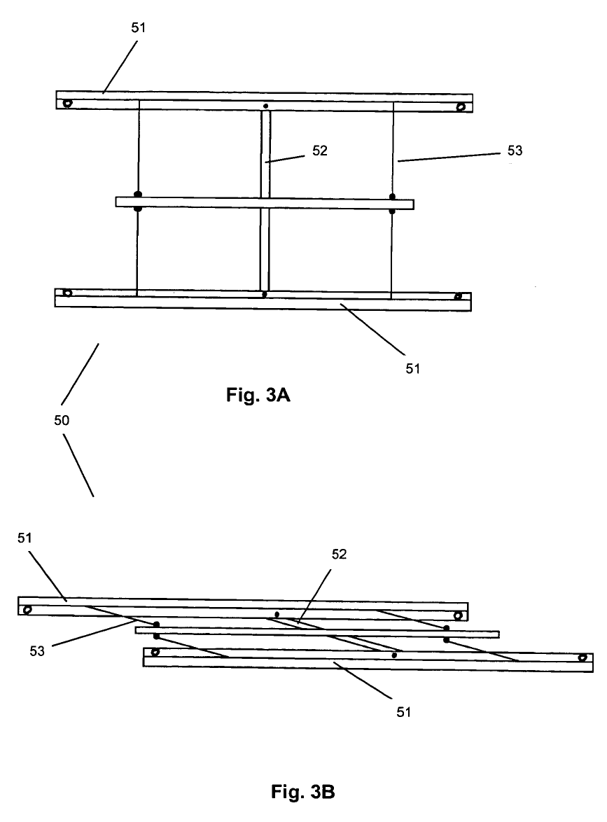

Embodiments may include on each individual apparatus 50 an outer bar 11, which may be located for example on 2 of the 4 sides of any individual apparatus 50. The outer bars 11 may be spread apart from one another by one or more spreader bars 12. For example, spreader bars 12 may be placed on an outer bar peg 17, which may serve to attach spreader bars 12 to outer bars 11, perhaps even without a permanent or fixed connection requiring nuts, bolts, tools, or the like. Spreader bars 12 may be held in place on an outer bar peg 17 by a tension inducing element, such as elastic straps 13 or the like, which may be stretched by use of the spreader bars 12. A tension inducing element, such as elastic straps 13 or the like, may add tension between the outer bars 11 holding the spreader bars 12 in place on the outer bar pegs 17. The characteristics of the tension inducing element of course may be selected to provide any desired amount or form of tension. Variables such as placement, numbers of elements, elasticity, and so forth, may be varied to accomplish this task. For example, the number of elastic straps 13 or the like in various embodiments may be selected based on factors such as the weight and size of products or materials to be placed on the individual apparatus 50, and moreover may be varied from apparatus 50 to apparatus 50. By varying the number of elastic straps 13 or the like, the amount of tension between the outer bars 11 may be varied. In FIGS. 3, 5, 6 and 7, eight elastic straps 13 are used only as an example of the number of potential straps or the like.

The spreader bars 12 further may be held in place by a cross bar 14. In some embodiments, cross bar 14 may swivel 24 on a cross bar pivot 18 located on the center spreader bar 27. Moreover, a cross bar peg 15 may be inserted into a cross bar peg hole 28, located for example on the spreader bars 12. The cross bar 14 length may be a function of the distance between the spreader bars 12, and may provide tension between the spreader bars 12 and the center spreader bar 27, thereby perhaps holding the cross bar pegs 15 in the cross bar peg holes 28 without requiring a permanent or fixed connection. This may allow for the cross bar 14 to easily swivel 24 on the center spreader bar 27 for rotation into position for the cross bar pegs 15 to be inserted into the cross bar peg holes 28.

The spreader bars 12 and center spreader bar 27 may be held to one or more of the outer bars 11 by any suitable connector, for example perhaps a spreader bar strap 16. This may prevent the spreader bars 12 and the center spreader bar 27 from becoming unconnected to the outer bar 11 and potentially lost or misplaced. Moreover, the cross bar 14 may be held to the center spreader bar 27 by a suitable connector, which perhaps simply may be the cross bar pivot 18, so that the cross bar 14 also may be connected to the outer bars 11. The outer bars 11 similarly may be held together by any suitable connector, which perhaps simply may be the tension induction element previously described, such as the elastic straps 13 or the like, thereby potentially preventing the outer bars 11 from becoming unconnected and possibly lost or misplaced. Thus the entire individual apparatus 50 may be connected together, potentially preventing all the parts from becoming lost or misplaced. Moreover, all the parts may be perhaps connected together without any permanent or fixed connection. This may solve the problem of lost connection parts or wasted time making a fixed or permanent connection, as the parts simply may slide onto one another using pegs (15, 17) and be held in place with tension, for example as produced by elastic straps 13 or the like. As mentioned, particular embodiments of the inventive technology may involve components that are all interconnected, whether with nuts and bolts, cord, straps, welds, rivets, crimps, knots, brads, or in other manners. Of course, such affords the advantage of reducing the risk of lost parts, and reducing the labor by obviating the need to store separated parts, and relocate same, and perhaps the need to track associations of parts with particular apparatus.

Such an assembly of the individual apparatus 50 may enable them to be reduced in size relative to their assembled configuration. For example, by removing the cross bar peg 15 from the cross bar peg hole 28 in the spreader bars 12 and swiveling 24 the cross bar 14 on the center spreader bar 27, the cross bar 14 may be positioned so as to be parallel to the spreader bars 12. By removing the spreader bars 12 from the outer bar pegs 17, the outer bars 11 may tend to constrict together because of the tension of the tension induction element, such as elastic straps 13 or the like. At this point, the spreader bars 12 and center spreader bar 27 may still be held in place by the appropriate connectors, such as spreader bar straps 16, and the entire individual apparatus 50 may be collapsed into a small unit. Moreover, this process may be accomplished simply, perhaps without tools. The entire individual apparatus 50 may remain held together by the tension induction element (such as elastic straps 13 or the like), the appropriate connectors (such as spreader bar straps 16), and the cross bar pivot 18. The entire collapsed individual apparatus 50 may then be stacked with other collapsed individual apparatus 50, perhaps resulting in a substantial space saving relative to the assembled state of the individual apparatus 50. The actual size ratio of assembled apparatus to collapsed apparatus may vary depending on the application of the technology. For example, ratios in various embodiments may vary from 5:1 to as much as 30:1, perhaps typically being a ratio of about 10:1 for plant applications.

Embodiments may involve stacking an individual apparatus 50 on another, for example by inserting an outer bar foot peg into an outer bar peg hole 19. In this manner, individual apparatus 50 may be stacked on one another to form a complete multiple apparatus 50 rack 29. Varying the foot length 26 may vary the number of individual apparatus 50 that may be stacked, perhaps limited only by factors external to the system, such as the height of any doors or trucks that the rack system may need to move into or through. Moreover, the load capacity of any individual apparatus 50 may be varied based on varying the type of outer bars 11, spreader bars 12, cross bar 14 and biasers (e.g., tension induction elements (such as elastic straps 13 or the like)) that are used. For example, by increasing the number of elastic straps 13 and/or by increasing the thickness of any or all of the various bars, it may be possible to increase the amount of weight an individual apparatus 50 can bear.

The amount of weight an individual apparatus 50 may safely accommodate may also be changed in various embodiments by changing the diameter 35 of one or more elastic straps 13, thereby perhaps changing the length 34 to which an elastic strap 13 may be stretched. Poisson's ratio (the ratio, in an elastic body under longitudinal stress, of the transverse strain to the longitudinal strain) may show this relationship. The length 34 of the elastic strap's 13 stretch may determine the amount of weight the elastic strap 13 may be able to hold on an individual apparatus 50 and may determine the size of the individual apparatus 50. Of course, this ratio may vary depending on the application to which the rack system may be put. In some embodiments, for example, perhaps including typical plant embodiments, the ratio may be between 0.1:1 and as much as 5:1, though perhaps typically being about 2:1.

The outer bar foot 21 foot length 26 may be varied in various embodiments to allow different sizes of plants, products, or other materials to be placed on an individual apparatus 50. Individual apparatus 50 also may be stacked on each other with varying differences of foot length 26, perhaps allowing for shipping of different sized products to efficiently utilize space during distribution. Of course, this also may serve to further reduce distribution and transportation costs.

The size of a rack system may be varied in various embodiments to accommodate the type of plants, products, or other materials to be placed on it. Often, the rack system may be fitted to a transportation device such as a shipping pallet 30, wheeled cart 31, or the like. This may provide stability to help move the rack system. In some embodiments, the bottom outer bar 23 may not have outer bar foot pegs 20 located on the bottom of outer bar foot 22. This may help to accommodate placing the rack 29 on a transportation device, such as a shipping pallet 30, wheeled cart 31, or the like, as the outer bar foot peg 20 otherwise might not allow for a stable placement on the transportation device. The rack system may be secured to the transportation device, such as a shipping pallet 30, wheeled cart 31, or the like, with any suitable fastener, such as a strap 32 or bolts 33 attached to the bottom outer bar foot 22, depending on the configuration of transportation device.

In some embodiments, a plant plug (a type of plant) tray 1, for example such as a PUNCHABLES® brand plug tray, or other item, may be placed on horizontal supports of a support apparatus for growing, shipment, storage and/or transportation. Each plug tray 1 may be comprise a matrix of individual plant cells 3. Each individual plant cell 3 may hold an individual plant unit 2, may comprise shoots 7, roots 6, and the like. The bottom of each individual plant cell 3 may include drainage slits 5, perhaps to allow water to exit the bottom of the individual plant cell 3. Roots 6 may be permitted to grow out of each individual plant cell 3, through the bottom of the plant tray 4 as the plant develops. The roots 6 may be air pruned when they come into contact with the correct ratio of air and air movement. This may cause the total number of roots 6 in the individual plant unit 2 to increase in number, in as much as any individual roots perhaps have become pruned. This may form a heavily rooted individual plant unit 2 which then may be “punched” through the bottom of the individual plant cell 3 by the downward force of a punch pin 8 in direction 9, for example as may be accomplished in the PUNCHABLES® brand system. In some embodiments, an air flow space 10 between apparatus may be varied by adjusting a foot length 26, perhaps to accommodate varying sizes and types of plants grown on the individual apparatus 50. For example, by increasing the foot length 26, more air flow 10 may be attained, allowing perhaps for greater root 6 pruning and plants with larger shoots 7 to be grown in each individual plant unit 2.

When individual apparatus 50 are stacked onto one another in various embodiments, the amount of air space 10 between each individual apparatus 50 in the stacked system may be varied from individual apparatus 50 to individual apparatus 50, for example so as to accommodate the size of the plants in any individual plant unit 2. This may allow for maximizing the air flow 10 while minimizing the total space required for the complete stacked system, which in turn perhaps may tend to maximize space utilization when shipping and decrease shipping costs accordingly.

The concept of varied foot lengths 26 in various embodiments may allow for different air flow spaces 10, which also may bring the height of any individual apparatus 50 either closer or further from the ground. This may allow the individual apparatus 50 to be adjusted to prevent employee back strain while working on the individual apparatus 50. It also may serve to accommodate different sized products placed on the individual apparatus, perhaps allowing for maximization of space utilization for shipping.

This simple size reduction of an apparatus (e.g., individual apparatus 50) into a compact unit may solve the problem of storage space required for large, bulky, uncollapsed rack systems. It may allow for reduced transportation costs, for example to the extent that trucks can ship fully assembled loads and return only every 10^{th} load or so. It also may eliminate the problem of lost or misplaced parts required to reassemble any individual apparatus 50. Moreover, the reusability of the apparatus may eliminate waste, so that there perhaps may be no disposal costs associated with the system. The system may be environmentally responsible by perhaps reducing fuel requirements for returning racks to the manufacturer and perhaps not generating materials that later may need to be disposed in land fills.

A rack system in various embodiments may be utilized as part of a space-efficient distribution system for plants. At the outset, one or more plants may be grown to at least some degree of maturity. The plant or plants may be placed in an individual apparatus 50 of a rack 29. The individual apparatus 50 may be combined with other individual apparatus as described herein, perhaps to create a rack system having plant-sustaining characteristics as described herein. For example, an air flow space 10 appropriate to the specific plants to be transported may be provided, and the spacing of individual apparatus 50 may be adjusted to accommodate the sizes of the specific plants to be transported. The plants may then be transported within the rack system from one location to another, such as from a grower to a retailer, by any suitable means, such as overland or by air. Plants may be nurtured during transport by the plant-sustaining characteristics of the rack system, in some cases perhaps even growing to a further level of maturity. Upon reaching the intended destination, plants may be removed from the rack system and handled appropriately. For example, punchable plants may be removed from the individual trays and punched into a new container, perhaps as may be accomplished by the PUNCHABLES® brand system. Likewise, plants may be left in the individual apparatus 50, and the individual apparatus perhaps may be used to organize plants on benches, tables, or other work spaces for display or further handling. Ultimately, individual apparatus 50 may be reduced in size as described herein and returned to their original or perhaps even another destination, where they may be reconstituted to their assembled state and utilized for further plant transportation. Of course, transporting at such a reduced size may carry the benefits described herein.

Although various embodiments herein may be described at least in part as related to plant applications, of course it should be understood that the inventive technology may be used with any item or items capable of being stored, transported, or otherwise utilized in conjunction with a rack system, consistent with the principles discussed herein.

As can be easily understood from the foregoing, the basic concepts of the present inventive technology may be embodied in a variety of ways. It involves both product distribution techniques as well as devices to accomplish the appropriate product distribution. In this application, the product distribution techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “stack” should be understood to encompass disclosure of the act of “stacking”—whether explicitly discussed or not—and, conversely, were there effectively disclosure of the act of “stacking”, such a disclosure should be understood to encompass disclosure of a “stack” and even a “means for stacking”. Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the rack devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-32. (canceled)

33. A support apparatus reconfigurable between support and collapsed configurations, said apparatus comprising:
two rigid, horizontal outer supports that are parallel with each other when said apparatus is in said support configuration;
a rigid horizontal support pivotally connected with both said two rigid horizontal outer supports; and
at least two additional horizontal supports pivotally connected with both said two rigid horizontal outer supports,
wherein said at least two additional horizontal supports comprises at least two tensile displacement resisting supports, and
wherein said two rigid, horizontal outer supports are revolvable relative to each other.

34. A support apparatus reconfigurable between support and collapsed configurations as described in claim 33 further comprising at least four feet that support said two rigid, horizontal outer supports.

35. A support apparatus reconfigurable between support and collapsed configurations as described in claim 34 wherein said feet are height adjustable.

36. A support apparatus reconfigurable between support and collapsed configurations as described in claim 33 wherein at least one of said at least two additional horizontal supports is pivotally connected with both said two rigid horizontal outer supports at respective non-terminal portions of said two rigid horizontal outer supports.

37. A support apparatus reconfigurable between support and collapsed configurations as described in claim 33 wherein said apparatus, when in said collapsed configuration, occupies a space having the same height as does that space occupied by said apparatus when in said support configuration.

38. A support apparatus reconfigurable between support and collapsed configurations as described in claim 33 wherein said tensile displacement resisting supports comprises cables.

39. A support apparatus reconfigurable between support and collapsed configurations as described in claim 33 wherein said tensile displacement resisting supports comprises elastic bands.

40. A support apparatus reconfigurable between support and collapsed configurations as described in claim 33 wherein said tensile displacement resisting supports comprises at least four tensile displacement resisting supports.

41. A support apparatus reconfigurable between support and collapsed configurations as described in claim 33 further comprising a rigid, horizontal inner support established in parallel relation with said two rigid, horizontal outer supports.

42. A support apparatus reconfigurable between support and collapsed configurations as described in claim 41 wherein said rigid, horizontal inner support is supported by said rigid horizontal support that is pivotally connected with both said two rigid horizontal outer supports.

43. A support apparatus reconfigurable between support and collapsed configurations as described in claim 33 wherein said apparatus is stackable above other similarly configured apparatus.

44. A support apparatus reconfigurable between support and collapsed configurations as described in claim 33 wherein said two rigid, horizontal outer supports are purely revolvable relative to each other.

45. A support apparatus reconfigurable between support and collapsed configurations as described in claim 33 wherein said support apparatus supports at least one plant rack

46. A support apparatus reconfigurable between support and collapsed configurations, said apparatus comprising:
two rigid, horizontal outer supports that are parallel with each other when said apparatus is in said support configuration; and
a rigid horizontal support pivotally connected with both said two rigid horizontal outer supports at respective non-terminal portions thereof,
wherein said two rigid, horizontal outer supports are revolvable relative to each other.

47. A support apparatus reconfigurable between support and collapsed configurations as described in claim 46 further comprising at least one additional horizontal support pivotally connected with both said two rigid horizontal outer supports.

48. A support apparatus reconfigurable between support and collapsed configurations as described in claim 47 wherein at least two of said horizontal supports pivotally connected with both of said two rigid horizontal outer supports are connected at non-terminal portions of said two rigid horizontal outer supports.

49. A support apparatus reconfigurable between support and collapsed configurations as described in claim 47 wherein at least one additional horizontal support comprises at least two additional horizontal supports.

50. A support apparatus reconfigurable between support and collapsed configurations as described in claim 49 wherein said at least two additional horizontal supports comprises at least two additional tensile displacement resisting supports.

51. A support apparatus reconfigurable between support and collapsed configurations as described in claim 49 wherein said tensile displacement resisting supports comprises cables.

52. A support apparatus reconfigurable between support and collapsed configurations as described in claim 49 wherein said tensile displacement resisting supports comprises elastic bands.

53. A support apparatus reconfigurable between support and collapsed configurations as described in claim 49 wherein said tensile displacement resisting supports comprises at least four tensile displacement resisting supports.

54. A support apparatus reconfigurable between support and collapsed configurations as described in claim 46 further comprising at least four feet that support said two rigid, horizontal outer supports.

55. A support apparatus reconfigurable between support and collapsed configurations as described in claim 54 wherein said feet are height adjustable.

56. A support apparatus reconfigurable between support and collapsed configurations as described in claim 46 wherein said apparatus, when in said collapsed configuration, occupies a space having the same height as does that space occupied by said apparatus when in said support configuration.

57. A support apparatus reconfigurable between support and collapsed configurations as described in claim 46 further comprising a rigid, horizontal inner support established in parallel relation with said two rigid, horizontal outer supports.

58. A support apparatus reconfigurable between support and collapsed configurations as described in claim 57 wherein said rigid, horizontal inner support is supported by said rigid horizontal support that is pivotally connected with both said two rigid horizontal outer supports

59. A support apparatus reconfigurable between support and collapsed configurations as described in claim 46 wherein said apparatus is stackable above other similarly configured apparatus.

60. A support apparatus reconfigurable between support and collapsed configurations as described in claim 46 wherein said support apparatus supports at least one plant rack.

61. A support apparatus reconfigurable between support and collapsed configurations as described in claim 46 wherein said two rigid, horizontal outer supports are purely revolvable relative to each other.

62-69. (canceled)

70. A support method comprising the steps of:
establishing two rigid, horizontal outer supports so as to be parallel with each other in both an apparatus support configuration and a collapsed configuration; and
pivotally connecting a rigid horizontal support and at least one tensile displacement resisting support to said two rigid, horizontal outer supports so as to enable revolutionary motion of said two rigid, horizontal outer supports relative to each other.

71. A support method as described in claim 70 wherein said revolutionary motion comprises pure revolutionary motion.

72. A support method as described in claim 70 wherein said step of pivotally connecting comprises the step of pivotally connecting at least one of said at least one tensile displacement resisting support to said two rigid, horizontal outer supports at non-terminal portions of said two rigid, horizontal outer supports.

73. A support method as described in claim 70 wherein said step of pivotally connecting a rigid horizontal support and at least one tensile displacement resisting support comprises the step of pivotally connecting said rigid horizontal support and at least one wire.

74. A support method as described in claim 70 wherein said step of pivotally connecting a rigid horizontal support and at least one tensile displacement resisting support comprises the step of pivotally connecting said rigid horizontal support and at least four tensile displacement resisting supports.
